(19) United States
(12) Patent Application Publication
(10) Pub. No.: US 2024/0006646 A1
(43) Pub. Date: Jan. 4, 2024

(54) METHOD FOR COORDINATED CONTROL OF ELECTRO-HYDROGEN INTEGRATED SYSTEM BASED ON BLOCKCHAIN SMART CONTRACT

(71) Applicants: Peking University, Beijing (CN); Peking University Ordos Research Institute of Energy, Ordos (CN)

(72) Inventors: Jianxiao Wang, Beijing (CN); Guannan He, Beijing (CN); Feng Gao, Beijing (CN); Jingsi Huang, Beijing (CN); Jie Song, Beijing (CN)

(21) Appl. No.: 18/343,218

(22) Filed: Jun. 28, 2023

(30) Foreign Application Priority Data
Jun. 30, 2022 (CN) 2022107612323

(51) Int. Cl. H01M 8/22

(52) U.S. Cl. CPC H01M 8/22

(57) ABSTRACT

A method for coordinated control of an electro-hydrogen integrated system includes: constructing a clearing model for the integrated system having a fuel cell facility and a P2H production facility; introducing Lagrange multipliers into a power balance constraint and a hydrogen energy balance constraint in the clearing model; decomposing the clearing model into a first clearing model of a power subsystem and a second clearing model of a hydrogen subsystem based on a decomposition algorithm, solving the first and second clearing models to obtain interaction information; storing the interaction information in a blockchain smart contract, exchanging the blockchain smart contract for multiple rounds and adjusting strategies of each subsystem to obtain an optimal solution of the clearing model; and controlling the integrated system based on the optimal solution to provide a target electric quantity and a target hydrogen amount.

### CROSS-REFERENCE TO RELATED APPLICATION

This application claims priority to Chinese Patent Application No. 2022107612323, filed on Jun. 30, 2022, the entire content of which is incorporated by reference herein.

### TECHNICAL FIELD

The disclosure belongs to a technical field of an electric-hydrogen integrated system participating in economic dispatch, and particularly relates to a method for coordinated control of an electro-hydrogen integrated system based on a blockchain smart contract, and an electro-hydrogen integrated system.

### BACKGROUND

As a water electrolysis hydrogen production technology is increasingly mature, a coupling degree between a power system and a hydrogen system is gradually deepening under the background that the water electrolysis hydrogen production will become a mainstream hydrogen production mode. Since the power system and the hydrogen system may protect their own internal information, it's unreasonable to conduct research that focuses on the power system and the hydrogen system in an actual operation, and it's necessary to research a coordinated control technology of an electric-hydrogen integrated system. However, when an existing decomposition algorithm is applied to the electro-hydrogen integrated system, a control center is generally required to collect each subject information and update a subject parameter based on a certain update policy, which leads to a huge burden for the control center.

### SUMMARY

According to a first aspect of the disclosure, a method for coordinated control of an electro-hydrogen integrated system based on a blockchain smart contract is provided. The method includes:

constructing a clearing model for the electro-hydrogen integrated system having a fuel cell facility and a power-to-hydrogen (P2H) production facility, wherein an objective function of the clearing model is represented by:

$$min {\sum }_{t ∈ {Φ}^{T}} ( {\sum }_{g ∈ {Φ}^{G}} {c}_{g , t}^{G} \cdot {P}_{g , t}^{G} + {\sum }_{h ∈ {Φ}^{H}} {c}_{h , t}^{H} \cdot {f}_{h , t}^{H} ) ,$$

where Φ^{T} represents a set of measurement moments, Φ^{G} represents a set of generator units, Φ^{H} represents a set of hydrogen sources; P_{g,t}^{G} represents an electric quantity produced by a generator unit g, f_{h,t}^{H} represents a hydrogen amount produced by a hydrogen source h at a t moment; and c_{g,t}^{G} represents a cost coefficient of the generator unit g producing electricity at the t moment, c_{h,t}^{H} represents a cost coefficient of the hydrogen source h producing hydrogen at the t moment;
introducing Lagrange multipliers into a power balance constraint and a hydrogen energy balance constraint in the clearing model;
decomposing the clearing model into a first clearing model of a power subsystem and a second clearing model of a hydrogen subsystem based on an optimal condition decomposition algorithm, solving the first clearing model and the second clearing model to obtain first Lagrange multipliers and first coupling variables of the power sub-system, and second Lagrange multipliers and second coupling variables of the hydrogen sub-system;
storing the first Lagrange multipliers and the first coupling variables, the second Lagrange multipliers and the second coupling variables in the blockchain smart contract, exchanging the blockchain smart contract for multiple rounds through the power sub-system and the hydrogen sub-system and adjusting strategies of the power sub-system and the hydrogen sub-system to obtain an optimal solution of the clearing model; and
controlling the electro-hydrogen integrated system based on the optimal solution to provide a target electric quantity and a target hydrogen amount.

According to a second aspect of the disclosure, an electro-hydrogen integrated system is provided. The integrated system includes a fuel cell facility and a power-to-hydrogen (P2H) production facility, configured to couple a power system and a hydrogen energy system. The integrated system also includes a controller configured to perform the method as described in the first aspect of the disclosure.

According to a third aspect of the disclosure, a non-transitory computer computer-readable storage medium is provided with a computer program stored thereon. When the computer program is executed by a processor, the method as described in the first aspect of the disclosure is implemented.

The additional aspects and advantages of the disclosure may be set forth in the following specification, and will become obvious from the following description, or may be learned by practice of the disclosure.

### BRIEF DESCRIPTION OF THE DRAWINGS

The above and/or additional aspects and advantages of the present disclosure will become obvious and easy to understand from the following description of the embodiments in conjunction with the accompanying drawings.

FIG. 1 is a flowchart illustrating a method for coordinated control of an electro-hydrogen integrated system based on a blockchain smart contract according to an embodiment of the present disclosure.

FIG. 2 is a structural diagram illustrating an apparatus for coordinated control of an electro-hydrogen integrated system based on a blockchain smart contract according to an embodiment of the present disclosure.

### DETAILED DESCRIPTION

Embodiments of the present disclosure are described in detail below, and examples of embodiments are illustrated in the accompanying drawings, in which the same or similar labels represent the same or similar elements or elements with the same or similar functions. The embodiments described below with reference to the drawings are exemplary, which is intended to explain the present disclosure and cannot be construed as a limitation of the present disclosure.

The disclosure provides a coordinated control technology of an electro-hydrogen integrated system based on a blockchain smart contract which stores interaction information. The blockchain smart contract is exchanged for multiple rounds through each subject of the electro-hydrogen integrated system and respective strategies are adjusted, to achieve an optimal control of the power system and the hydrogen system.

The method according to the embodiments of the present disclosure has the following advantages:
(1) Compared with a centralized mechanism design of an electro-hydrogen integrated system in the related art, a coordination problem of the power system and the hydrogen system during the decomposition is studied in the disclosure, and considering that the intention of the power system and the hydrogen system to protect their own internal information, the interaction information is stored in the smart contract during the actual operation of the power system and the hydrogen system.
(2) Compared with a conventional Lagrange decomposition algorithm in the related art that brings a huge burden to a market transaction center, an improvement to the conventional Lagrange decomposition algorithm is made. That is, the electro-hydrogen integrated system is decomposed into the power sub-system and the hydrogen sub-system, each of which maintains their own coupling constraint, and the Lagrange multiplier does not need to be updated during a coordination stage.
(3) Compared with the hydrogen system constructed in the related art, a power balance constraint and a hydrogen balance constraint in the clearing model of the electro-hydrogen integrated system are rewritten by introducing a marginal price mechanism, so as to reflect key information in the electro-hydrogen integrated system better.

The method and apparatus for coordinated control of an electro-hydrogen integrated system based on a blockchain smart contract in the embodiments of the present disclosure is described below with reference to the attached drawings.

### Embodiment 1

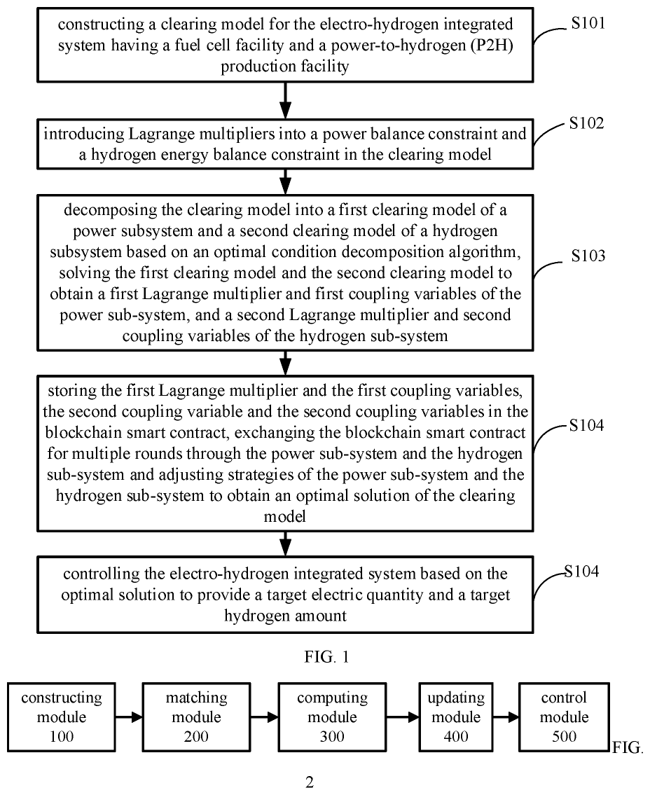

FIG. 1 is a flowchart illustrating a method for coordinated control of an electro-hydrogen integrated system based on a blockchain smart contract according to an embodiment of the present disclosure.

As illustrated in FIG. 1, the method for coordinated control of an electro-hydrogen integrated system based on a blockchain smart contract includes the following steps.

At S101, a clearing model is constructed for the electro-hydrogen integrated system having a fuel cell facility and a power-to-hydrogen (P2H) production facility. An objective function of the clearing model is represented by:

$$min {\sum }_{t ∈ {Φ}^{T}} ( {\sum }_{g ∈ {Φ}^{G}} {c}_{g , t}^{G} \cdot {P}_{g , t}^{G} + {\sum }_{h ∈ {Φ}^{H}} {c}_{h , t}^{H} \cdot {f}_{h , t}^{H} )$$

where Φ^{T} represents a set of measurement moments, Φ^{G} represents a set of generator units, Φ^{H} represents a set of hydrogen sources; P_{g,t}^{G} represents an electric quantity produced by a generator unit g, f_{h,t}^{H} represents a hydrogen amount produced by a hydrogen source h at a t moment; and c_{g,t}^{G} represents a cost coefficient of the generator unit g producing electricity at the t moment, c_{h,t}^{H} represents a cost coefficient of the hydrogen source h producing hydrogen at the t moment.

At S102, Lagrange multipliers are introduced into a power balance constraint and a hydrogen energy balance constraint in the clearing model.

At S103, the clearing model of the electro-hydrogen integrated system is decomposed into a first clearing model of a power subsystem and a second clearing model of a hydrogen subsystem based on an optimal condition decomposition algorithm, the first clearing model and the second clearing model are solved to obtain first Lagrange multipliers and first coupling variables of the power sub-system, and second Lagrange multipliers and second coupling variables of the hydrogen sub-system.

At S104, the first Lagrange multipliers and the first coupling variables, the second Lagrange multipliers and the second coupling variables are stored in the blockchain smart contract, the blockchain smart contract is exchanged for multiple rounds through the power sub-system and the hydrogen sub-system, and strategies of the power sub-system and the hydrogen sub-system are adjusted to obtain an optimal solution of the clearing model of the electro-hydrogen integrated system.

At S105, the electro-hydrogen integrated system is controlled based on the optimal solution to provide a target electric quantity and a target hydrogen amount.

In an embodiment, a power balance constraint of each node in a power system is defined by:

$${\sum }_{g ∈ {Φ}_{m}^{G}} {P}_{g , t}^{G} + {\sum }_{i ∈ {Φ}_{m}^{RG}} {P}_{i , t}^{RG} + {\sum }_{i ∈ {Φ}_{m}^{G}} {P}_{i , t}^{FC} - {\sum }_{i ∈ {Φ}_{m}^{G}} {P}_{i , t}^{P 2 H} - {\sum }_{n ∈ {Φ}_{m}} {P}_{mn , t}^{f} = {p}_{m , t}^{D}$$

$$∀ t , m ,$$

where Φₘ^{G} represents a set of thermal power generator units, Φₘ^{RG} represents a set of new energy generator units and Φₘ represents a set of nodes connected to a node m; P_{i,t}^{RG} represents an active power output of a new energy generator unit i at a t moment, P_{i,t}^{FC} represents an active power output of a fuel cell i at the t moment, P_{i,t}^{P2H} represents a power consumed by a P2H production facility i at the t moment, P_{m,t}^{D} represents a power demand of a node i at the t moment, and P_{mn,t}^{f} represents a power transmitted from the node m to a node n at the t moment; and
a hydrogen balance constraint of each node in a hydrogen energy system is defined by:

$${\sum }_{h ∈ m} {f}_{h , t}^{H} - {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{P 2 H} - {\sum }_{i ∈ m} {f}_{i , t}^{FC} = {f}_{m , t}^{D}$$

$$∀ t , m ,$$

where Ω_{I}(mn)=m represents a set of hydrogen pipelines with the node m as an input node; Ω_{O}(mn)=m represents a set of hydrogen pipelines with the node m as an output node; f_{mn,t}^{t} represents a hydrogen amount input by a hydrogen pipeline mn at the node m at the t moment, f_{mn,t}^{O} represents a hydrogen amount output by the hydrogen pipeline mn at the node m at the t moment; f_{i,t}^{FC} represents a hydrogen consumption of the fuel cell i; f_{i,t}^{P2H} represents a hydrogen production amount of the P2H production facility i; and f_{m,t}^{D} represents a hydrogen energy demand amount of the node m at the t moment.

In another embodiment, a power constraint of a transmission line in the power system is defined by:

P_{mn,t}^{f}=Bₘₙ(θ_{m,t}−θ_{n,t}) ∀t,m,nϵΦₘ,

−P_{mn,max}^{f}≤P_{mn,t}^{f}≤P_{mn,max}^{f} ∀t,m,nϵΦₘ
where P_{mm,max}^{f} represents an upper limit of the transmitting power of the electric transmission line from the node m to a node n;
an output constraint of a set of thermal power generator units is defined by:

P_{i,min}^{G}≤P_{i,t}^{G}≤P_{i,max}^{G} ∀i,t,
where P_{i,max}^{G} represents an output upper limit of a set of thermal power generator units i, and P_{i,min}^{G} represents an output lower limit of the set of thermal power generator units i; and
an output constraint of a set of renewable energy generator units is defined by

0≤P_{i,t}^{RG}≤P_{i,t}^{FRG} ∀i,t
where P_{i,t}^{FRG} represents an active power output predicted value of a set of renewable energy units i at the moment t.

In another embodiment, a hydrogen pipeline constraint is defined by:

$$\{ \begin{matrix}{f}_{mn , t} = sgn ( {p}_{m , t} , {p}_{n , t} ) \cdot {S}_{mn} \cdot \sqrt{\vert {p}_{m , t}^{2} - {p}_{n , t}^{2} \vert} \\ sgn ( {p}_{m , t} , {p}_{n , t} ) = \{ \begin{matrix}1 & {p}_{m , t} > {p}_{n , t} \\ - 1 & {p}_{m , t} < {p}_{n , t}\end{matrix}\end{matrix} ∀ mn ∈ {Φ}^{L} , t ,$$

where Φ^{L} represents a set of hydrogen pipelines, f_{mn,t} represents a hydrogen amount transmitted by a hydrogen pipeline mn at the t moment, Sₘₙ represents a constant determined by a length, a diameter and a temperature of the pipeline mn, and sgn(p_{m,t},p_{n,t}) represents a sign function of a hydrogen flow direction, and a hydrogen flow is determined by

$${f}_{mn , t} = \frac{{f}_{mn , t}^{I} + {f}_{mn , t}^{O}}{2} ∀ mn ∈ {Φ}^{L} , t$$

a hydrogen flow constraint in the hydrogen pipeline is defined by

−f_{mn,max}≤f_{mn,max}≤_{mn,max} ∀mnϵΦ^{L},t,
where f_{mn,max} represents a capacity limit of the pipeline mn;
a pipeline component constraint is determined by:

$${F}_{mn , t} = {F}_{mn , t - 1} + {f}_{mn , t}^{I} - {f}_{mn , t}^{O} ∀ mn ∈ {Φ}^{L} , t ,$$

$${F}_{mn , t} = {μ}_{mn} \cdot \frac{{p}_{m , t} + {p}_{n , t}}{2} ∀ mn ∈ {Φ}^{L} , t$$

where F_{mn,t} represents a hydrogen storage amount within the hydrogen pipeline mn at the t moment, μₘₙ represents a constant determined by a length, a diameter and a temperature of the hydrogen pipeline mn;
a hydrogen production constraint of the hydrogen energy system is defined by

f_{h,min}^{H}≤f_{h,t}^{H}≤f_{h,max}^{H} ∀h,t
where f_{h,max}^{H} represents an upper limit of a hydrogen production capacity of a hydrogen production source h and f_{h,min}^{H} represents a lower limit of the hydrogen production capacity of the hydrogen production source h;
a hydrogen pressure constraint is represented by:

p_{m,min}≤p_{m,t}≤p_{m,max} ∀m,t,
where p_{m,t} represents a hydrogen pressure of the node m at the t moment, p_{m,max} represents an upper limit of the hydrogen pressure of the node m, and p_{m,min} represents a lower limit of the hydrogen pressure of the node m.

In an embodiment, introducing Lagrange multipliers into the power balance constraint and the hydrogen energy balance constraint in the clearing model includes:
introducing a dual variable of the power balance constraint at each node in the power system:

$${\sum }_{g ∈ {Φ}_{m}^{G}} {P}_{g , t}^{G} + {\sum }_{i ∈ {Φ}_{m}^{RG}} {P}_{i , t}^{RG} + {\sum }_{i ∈ {Φ}_{m}^{G}} {P}_{i , t}^{FC} - {\sum }_{i ∈ {Φ}_{m}^{G}} {P}_{i , t}^{P 2 H} - {\sum }_{n ∈ {Φ}_{m}} {P}_{mn , t}^{f} = {p}_{m , t}^{D} : {λ}_{m , t}^{LMP}$$

$$∀ t , m ,$$

where λ_{m,t}^{LMP} represents the introduced dual variable of the power balance constraint; and
introducing a dual variable of the hydrogen balance constraint at each node in the hydrogen energy system:

$${\sum }_{h ∈ m} {f}_{h , t}^{H} - {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{P 2 H} - {\sum }_{i ∈ m} {f}_{i , t}^{FC} = {f}_{m , t}^{D} : {λ}_{m , t}^{MHP}$$

$$∀ t , m ,$$

where λ_{m,t}^{MHP} represents the introduced dual variable of the hydrogen balance constraint.

In an embodiment, the method further includes: maintaining coupling constraints while decomposing the clearing model into the first clearing model of the power subsystem and the second clearing model of the hydrogen subsystem.

In another embodiment, the coupling constraints comprise:

$${f}_{i , t}^{P 2 H} = \frac{{P}_{i , t}^{P 2 H} \cdot 3600}{HHV \cdot {η}_{i}^{P 2 H}} ∀ i , t ,$$

$${P}_{i , t}^{FC} = \frac{{f}_{i , t}^{FC} \cdot HHV \cdot {η}_{i}^{FC}}{3600} ∀ i , t ,$$

$$0 \leq {f}_{i , t}^{P 2 H} \leq {f}_{i , max}^{P 2 H} ∀ i , t ,$$

$$0 \leq {P}_{i , t}^{FC} \leq {P}_{i , max}^{FC} ∀ i , t ,$$

where represents an installed capacity of the fuel cell facility, f_{i,max}^{P2H} represents an installed capacity of the P2H production facility, p_{m,max} represents an upper limit of a hydrogen pressure of the node m at the t moment, p_{m,min} represents a lower limit of the hydrogen pressure of the node m at the t moment.

In an embodiment, an objective function of the decomposed first clearing model is represented by:

$$min {\sum }_{t ∈ {Φ}^{T}} [ {\sum }_{t ∈ {Φ}^{G}} {c}_{i , t}^{G} \cdot {P}_{g , t}^{G} + {\sum }_{i ∈ {Φ}^{FC}} {\overline{μ}}_{i , t} ( {P}_{i , t}^{FC} - \frac{{\overline{f}}_{i , t}^{FC} \cdot HHV \cdot {η}_{i}^{FC}}{3600} ) ] ,$$

the objective function meets the power balance constraint, and a coupling constraint of

$$\frac{{P}_{i , t}^{P 2 H} \cdot 3600}{HHV \cdot {η}_{i}^{P 2 H}} - {\overline{f}}_{i , t}^{P 2 H} = 0 : {φ}_{i , t} ∀ i , t ,$$

where μ̅_{i,t} represents a fixed Lagrange multiplier obtained from the hydrogen sub-system, f̅_{i,t}^{FC} and f̅_{i,t}^{P2H} represent the first coupling variables, and φ_{i,t} represents a Lagrange multiplier of the coupling constraint. The first Lagrange multipliers include the fixed Lagrange multiplier obtained from the hydrogen sub-system and the Lagrange multiplier of the coupling constraint.

In an embodiment, an objective function of the decomposed second clearing model is represented by:

$$min {\sum }_{t ∈ {Φ}^{T}} [ {\sum }_{t ∈ {Φ}^{H}} {c}_{h , t}^{H} \cdot {f}_{h , t}^{H} + {\sum }_{t ∈ {Φ}^{P 2 H}} {\overline{φ}}_{i , t} ( {f}_{i , t}^{P 2 H} - \frac{{\overline{P}}_{i , t}^{P 2 H} \cdot 3600}{HHV \cdot {η}_{i}^{P 2 H}} ) ] ,$$

the objective function meets the hydrogen energy balance constraint, and a coupling constraint of

$$\frac{{f}_{i , t}^{FC} \cdot HHV \cdot {η}_{i}^{FC}}{3600} - {\overline{P}}_{i , t}^{FC} = 0 : {μ}_{i , t} ∀ i , t ,$$

where φ_{i,t} represents a fixed Lagrange multiplier obtained from the power sub-system, P̅_{i,t}^{FC} and P̅_{i,t}^{P2H} represent the second coupling variables, and μ_{i,t} represents a Lagrange multiplier of the coupling constraint. The second Lagrange multipliers include the fixed Lagrange multiplier and the Lagrange multiplier of the coupling constraint.

### Embodiment 2

1) A Clearing Model of an Electro-Hydrogen Coupling System with a Network Topology Structure is Considered.

The power system and the hydrogen system are coupled by a power-to-hydrogen production (P2H) facility and a fuel cell facility. As a share of water electrolysis hydrogen production in a hydrogen production industry is increasing, a degree of coupling between the power system and the hydrogen system is gradually deepening. In order to study a joint operation mechanism of the power system and the hydrogen system and explore an influence of bidirectional conversion between power energy and hydrogen on system clearing, a clearing model of an electro-hydrogen coupling system considering a network topology structure is constructed.

In order to facilitate detailed description of a relationship between a power parameter and a hydrogen parameter in the electro-hydrogen coupling system and further simplify calculation, the following assumptions are given:
in a first assumption, an electro-hydrogen integrated system is only considered;
in a second assumption, refined modeling the P2H facility and the fuel cell facility is ignored, and an electro-hydrogen conversion relationship is linear.

### (1) Construction of an Objective Function of the Electro-Hydrogen Coupling System

$$min {\sum }_{t ∈ {Φ}^{T}} ( {\sum }_{g ∈ {Φ}^{G}} {c}_{g , t}^{G} \cdot {P}_{g , t}^{G} + {\sum }_{h ∈ {Φ}^{H}} {c}_{h , t}^{H} \cdot {f}_{h , t}^{H} ) \qquad ( 1 )$$

where Φ^{T} represents a set of measurement moments, Φ^{G} represents a set of generator units, Φ^{H} represents a set of hydrogen sources; P_{g,t}^{G} represents an electric quantity produced by a generator unit g, f_{h,t}^{H} represents a hydrogen amount produced by a hydrogen source h at a t moment; and c_{g,t}^{G} represents a cost coefficient of the generator unit g producing electricity at the t moment, c_{h,t}^{H} represents a cost coefficient of the hydrogen source h producing hydrogen at the t moment.

The objective function of the coupling system with an object of minimizing the operation cost of the electro-hydrogen coupling system is represented in the equation (1). It needs to be noted that, the P2H facility and the fuel cell facility are energy conversion devices included in the integrated system, and they are not included in a set of generators and a set of hydrogen resources in the objective function.

1-2) Construction of the Power System Constraint

The power balance constraint of each node in a power system is defined by:

$${\sum }_{g ∈ {Φ}_{m}^{G}} {P}_{g , t}^{G} + {\sum }_{i ∈ {Φ}_{m}^{RG}} {P}_{i , t}^{RG} + {\sum }_{i ∈ {Φ}_{m}^{G}} {P}_{i , t}^{FC} - {\sum }_{i ∈ {Φ}_{m}^{G}} {P}_{i , t}^{P 2 H} - {\sum }_{n ∈ {Φ}_{m}} {P}_{mn , t}^{f} = {p}_{m , t}^{D} \qquad ( 2 )$$

$$∀ t , m$$

where Φₘ^{G} represents a set of thermal power generator units, Φₘ^{RG} represents a set of new energy generator units and Φₘ represents a set of nodes connected to a node m; P_{i,t}^{RG} represents an active power output of a new energy generator unit i at a t moment, P_{i,t}^{FC} represents an active power output of a fuel cell i at the t moment, P_{i,t}^{P2H} represents a power consumed by a P2H production facility i at the t moment, P_{m,t}^{D} represents a power demand of a node i at the t moment, and P_{mn,t}^{f} represents a power transmitted from the node m to a node n at the t moment.

The power constraint of a transmission line in a power system is defined by:

P_{mn,t}^{f}=Bₘₙ(θ_{m,t}−θ_{n,t}) ∀t,m,nϵΦₘ (3)

−P_{mn,max}^{f}≤P_{mn,t}^{f}≤P_{mn,max}^{f} ∀t,m,nϵΦₘ (4)

where the equation (3) represents a relationship between a node phase angle and a transmitting power of an electric transmission line from the node m to the node n, and the equation (4) represents an upper limit constraint and a lower limit constraint of the transmitting power of the electric transmission line. P_{mn,max}^{f} represents the upper limit of the transmitting power of the electric transmission line from the node m to the node n.

The output constraint of a set of thermal power generator units is defined by:

P_{i,min}^{G}≤P_{i,t}^{G}≤P_{i,max}^{G} ∀i,t (5)
where P_{i,max}^{G} represents an output upper limit of a set of thermal power generator units i, and P_{i,min}^{G} represents an output lower limit of the set of thermal power generator units i.

The output constraint of a set of renewable energy generator units is defined by:

0≤P_{i,t}^{RG}≤P_{i,t}^{FRG} ∀i,t (6)
where P_{i,t}^{FRG} represents an active power output predicted value of a set of renewable energy units i at the moment t. The equation (6) indicates that an output predicted value of the set of renewable energy units is greater than an actual output of the set of renewable energy units.

1-3) Construction of a Hydrogen Energy System Constraint

The hydrogen balance constraint of each node in a hydrogen energy system is defined by:

$${\sum }_{h ∈ m} {f}_{h , t}^{H} + {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{FC} = {f}_{m , t}^{D} ∀ m , t \qquad ( 7 )$$

where Ω_{I}(mn)=m represents a set of hydrogen pipelines with the node m as an input node; Ω_{O}(mn)=m represents a set of hydrogen pipelines with the node m as an output node; f_{mn,t}^{I} represents a hydrogen amount input by a hydrogen pipeline mn at the node m at the t moment, f_{mn,t}^{O} represents a hydrogen amount output by the hydrogen pipeline mn at the node m at the t moment; f_{i,t}^{FC} represents a hydrogen consumption of the fuel cell i; f_{i,t}^{P2H} represents a hydrogen production amount of the P2H production facility i; and f_{m,t}^{D} represents a hydrogen energy demand amount of the node m at the t moment. The hydrogen balance constraint of each node in the hydrogen energy system is represented in the equation (7).

Hydrogen Pipeline Constraint

In the hydrogen energy system, the hydrogen amount in the hydrogen pipeline is a function with respect to hydrogen pressures at both ends of the pipeline.

$$\{ \begin{matrix}{f}_{mn , t} = sgn ( {p}_{m , t} , {p}_{n , t} ) \cdot {S}_{mn} \cdot \sqrt{\vert {p}_{m , t}^{2} - {p}_{n , t}^{2} \vert} \\ sgn ( {p}_{m , t} , {p}_{n , t} ) = \{ \begin{matrix}1 & {p}_{m , t} > {p}_{n , t} \\ - 1 & {p}_{m , t} < {p}_{n , t}\end{matrix}\end{matrix} ∀ mn ∈ {Φ}^{L} , t \qquad ( 8 )$$

where Φ^{L} represents a set of hydrogen pipelines, f_{mn,t} represents a hydrogen amount transmitted by a hydrogen pipeline mn at the t moment, Sₘₙ represents a constant determined by a length, a diameter and a temperature of the pipeline mn, and sgn(p_{m,t},p_{n,t}) represents a sign function of a hydrogen flow direction. The equation (8) indicates a Weymouth equation that is a function relationship between the hydrogen amount transmitted in the hydrogen pipeline and the hydrogen pressures at both ends of the pipeline. It is to be noted that, the Weymouth equation is a non-linear equation, so that the clearing model of the hydrogen energy system becomes a non-convex problem. The Weymouth equation is processed by adopting a second-order conic relaxation method.

The average value of a hydrogen input flow in the pipeline and a hydrogen output flow in the pipeline is considered as a hydrogen flow, which is shown in an equation (9).

$${f}_{mn , t} = \frac{{f}_{mn , t}^{I} + {f}_{mn , t}^{O}}{2} ∀ mn ∈ {Φ}^{L} , t \qquad ( 9 )$$

Hydrogen flow constraint in the hydrogen pipeline

−f_{mn,max}≤f_{mn,max}≤_{mn,max} ∀mnϵΦ^{L},t (10)
where f_{mn,max} represents a capacity limit of the pipeline mn.

Pipeline Component Constraint

A delay property of hydrogen transmission is described by adopting a pipeline component model. The delay property of hydrogen transmission enables the hydrogen pipeline to have a similar function as an energy storage device. The pipeline component model is constructed by:

$${F}_{mn , t} = {F}_{mn , t - 1} + {f}_{mn , t}^{I} - {f}_{mn , t}^{O} ∀ mn ∈ {Φ}^{L} , t \qquad ( 11 )$$

$${F}_{mn , t} = {μ}_{mn} \cdot \frac{{p}_{m , t} + {p}_{n , t}}{2} ∀ mn ∈ {Φ}^{L} , t \qquad ( 12 )$$

where F_{mn,t} represents a hydrogen storage amount within the hydrogen pipeline mn at the t moment, μₘₙ represents a constant determined by the length, the diameter and the temperature of the hydrogen pipeline mn. The equation (11) represents a time coupling constraint of the pipeline component, and the equation (12) represents a method for determining a hydrogen storage amount within the pipeline at the t moment.

### Hydrogen Production Constraint of a Hydrogen Energy System

A hydrogen production capacity cannot exceed a specified upper limit and a specified lower limit, which is represented by the equation (13).

f_{h,min}^{H}≤f_{h,t}^{H}≤f_{h,max}^{H} ∀h,t (13)
where f_{h,max}^{H} represents an upper limit of a hydrogen production capacity of a hydrogen production source h and f_{h,min}^{H} represents a lower limit of the hydrogen production capacity of the hydrogen production source h. The equation (13) represents the hydrogen production constraint of the hydrogen energy system.

A hydrogen pressure constraint is represented by:

p_{m,min}≤p_{m,t}≤p_{m,max} ∀m,t (14)

where p_{m,t} represents a hydrogen pressure of the node m at the t moment, p_{m,max} represents an upper limit of the hydrogen pressure of the node m, and p_{m,min} represents a lower limit of the hydrogen pressure of the node m.

1-4) Construction of the Electro-Hydrogen Coupling System Constraint

The power system and the hydrogen system are coupled by the P2H production facility and the fuel cell facility. The electro-hydrogen coupling system meets the following constraints:

$${f}_{i , t}^{P 2 H} = \frac{{P}_{i , t}^{P 2 H} \cdot 3600}{HHV \cdot {η}_{i}^{P 2 H}} ∀ i , t \qquad ( 15 )$$

$${f}_{i , t}^{FC} = \frac{{P}_{i , t}^{FC} \cdot HHV \cdot {η}_{i}^{FC}}{3600} ∀ i , t \qquad ( 16 )$$

$$0 \leq {f}_{i , t}^{P 2 H} \leq {f}_{i , max}^{P 2 H} ∀ i , t \qquad ( 17 )$$

$$0 \leq {f}_{i , t}^{P 2 H} \leq {f}_{i , max}^{P 2 H} ∀ i , t \qquad ( 18 )$$

where P_{i,max}^{FC} represents an installed capacity of the fuel cell facility, and f_{i,max}^{P2H} represents an installed capacity of the P2H production facility. The hydrogen pressure of the node m at the t moment has an upper limit denoted by p_{m,max} and a lower limit p_{m,min}. The equation (15) represents an electro-hydrogen conversion relationship of the P2H production facility, and the equation (16) represents an electro-hydrogen conversion relationship of the fuel cell facility, and the equation (15) is constrained by the equation (17) and the equation (16) is constrained by the equation (18).
2) a power balance constraint and a hydrogen energy balance constraint in the clearing model of the electro-hydrogen coupling system acquired based on step 1) is rewritten to introduce a marginal price mechanism.

A dual variable is introduced into the constraint represented by the equation (2):

$${\sum }_{g ∈ {Φ}_{m}^{G}} {P}_{g , t}^{G} + {\sum }_{i ∈ {Φ}_{m}^{RG}} {P}_{i , t}^{RG} + {\sum }_{i ∈ {Φ}_{m}^{G}} {P}_{i , t}^{FC} - {\sum }_{i ∈ {Φ}_{m}^{G}} {P}_{i , t}^{P 2 H} - {\sum }_{n ∈ {Φ}_{m}} {P}_{mn , t}^{f} = {p}_{m , t}^{D} : {λ}_{m , t}^{LMP} \qquad ( 19 )$$

$$∀ t , m$$

where λ_{m,t}^{LMP} represents the introduced dual variable to represent a locational marginal price (LMP).

A dual variable is introduced into the constraint represented by the equation (7):

$${\sum }_{h ∈ m} {f}_{h , t}^{H} + {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{P 2 H} - {\sum }_{i ∈ m} {f}_{i , t}^{FC} = {f}_{m , t}^{D} : {λ}_{m , t}^{MHP} \qquad ( 20 )$$

$$∀ m , t$$

where λ_{m,t}^{MHP} represents the introduced dual variable to represent a marginal hydrogen price (MHP).

Through the dual variables introduced into the power balance constraint and the hydrogen energy balance constraint, key information in the electro-hydrogen integrated system may be well reflected. As such, the optimal solution of the electro-hydrogen integrated system may be used to accurately control the amount of various energies in the integrated system.

3) Method for Decomposition Coordination of the Electro-Hydrogen Integrated System Based on the Blockchain Smart Contract

When the clearing model of the electro-hydrogen integrated system is directly solved, it is unable to explore internal system information due to a high computation complexity, and it is difficult to solve the electro-hydrogen integrated system in a centralized way. Therefore, the clearing model of the electro-hydrogen integrated system considering the network topology structure is solved based on an optimal condition decomposition algorithm.

3-1) General Form of the Blockchain Smart Contract

The general form of the optimal condition decomposition algorithm is:

$${min}_{x} {\sum }_{n = 1}^{N} {f}_{n} ( {x}_{n} ) \qquad ( 21 )$$

so that the constraint in the following equation (22) is established.

$$\{ \begin{matrix}{h}_{n} ( {x}_{n} ) = 0 , n = 1 , 2 , … , N \\ {c}_{n} ( {x}_{1} , {x}_{2} , … , {x}_{N} ) = 0 , n = 1 , 2 , … , N\end{matrix} \qquad ( 22 )$$

where hₙ(xₙ)=0, n=1, 2, . . . ,N represents a simple constraint and cₙ(x₁, x₂, . . . , x_{N})=0, n=1, 2 . . . N represents a coupling constraint.

The original/primal problem may be equivalently transformed to:

$${min}_{x} {\sum }_{n = 1}^{N} {f}_{n} ( {x}_{n} ) + {\sum }_{n = 1}^{N} {λ}_{n}^{T} {c}_{n} ( {x}_{1} , {x}_{2} , … , {x}_{N} ) \qquad ( 23 )$$

so that the constraint in the equation (22) is established. λₙ represents a Lagrangian multiplier of a constraint cₙ=0.

Decomposition of the primal problem is achieved by fixing a specific set of optimization variables and a Lagrange multiplier. An equivalence problem is decomposed into N sub-problems in the following forms by fixing an optimization variable and a Lagrange multiplier in other set.

$${min}_{x} {f}_{n} ( {x}_{n} ) + {{\sum }_{m = 1 , m \neq n}}^{N} {λ}_{m}^{T} {c}_{m} ( {\overline{x}}_{1} , … , {x}_{n} , … , {\overline{x}}_{N} ) \qquad ( 24 )$$

so that a constraint in the following equation (25) is established.

$$\{ \begin{matrix}{h}_{n} ( {x}_{n} ) = 0 \\ {c}_{n} ( {\overline{x}}_{1} , … , {x}_{n} , … , {\overline{x}}_{N} ) = 0\end{matrix} \qquad ( 25 )$$

In the equation (24) and the equation (25), overlapping variables (i.e., x₁, . . . , x_{N}) may represent given values of the optimization variable, and λ̅ₘ^{T} represents the Lagrange multiplier. All sub-problems may be independently solved by fixing the optimization variable value and the Lagrange multiplier value in other set. Subsequently, all sub-problems are iteratively solved to obtain an optimal solution of the primal problem.

In the embodiments of the disclosure, the optimal solution may refer to a conversion amount between a power generation amount of the generator and a hydrogen production amount of the hydrogen production device as well as a conversion amount between electric energy and hydrogen energy in the electro-hydrogen coupling system. 3-2) Optimal condition decomposition algorithm for the electro-hydrogen integrated system

The electro-hydrogen integrated system is decomposed by adopting the optimal condition decomposition algorithm. The electro-hydrogen integrated system is decomposed into an independent power system and an independent hydrogen energy system, and coupling constraints in the equations (15) and (16) of the power-hydrogen system are relaxed. In addition, each sub-problem is iteratively solved, and the optimization variable and the Lagrange multiplier are updated, to finally obtain an optimal solution of the clearing model of the integrated system. In the embodiments of the disclosure, the fixed Lagrange multiplier in the following equations (27) and (29) are updated. The optimization variable may include the following coupling variables in the clearing model of the power or hydrogen system, the above-mentioned conversion amount between electric energy and hydrogen energy, and the above-mentioned conversion amount between a power generation amount of the generator and a hydrogen production amount of the hydrogen production device. By iteratively updating the optimization variable and the Lagrange multiplier, an optimal conversion amount is obtained, so as to control the operation of the electro-hydrogen coupling system.

The decomposed power system model and the hydrogen system model are as follow.

### Clearing Model of the Power System

The objective function of the clearing model of the power system is as follow:

$$min {\sum }_{t ∈ {Φ}^{T}} [ {\sum }_{i ∈ {Φ}^{G}} {c}_{i , t}^{G} \cdot {P}_{g , t}^{G} + {\sum }_{i ∈ {Φ}^{FC}} {\overline{μ}}_{i , t} ( {P}_{i , t}^{FC} - \frac{{\overline{f}}_{i , t}^{FC} \cdot HHV \cdot {η}_{i}^{FC}}{3600} ) ] \qquad ( 26 )$$

so that the constraints in the equations (2) to (6) and the constraints in the equations (18) and (27) are established.

$$\frac{{P}_{i , t}^{P 2 H}}{HHV \cdot {η}_{i}^{P 2 H}} - {\overline{f}}_{i , t}^{P 2 H} = 0 : {φ}_{i , t} ∀ i , t \qquad ( 27 )$$

where μ̅_{i,t} represents the fixed Lagrange multiplier in the clearing model of the power system, f̅_{i,t}^{FC} and f̅_{i,t}^{P2H} represent coupling variables in the clearing model of the power system; and φ_{i,t} represents a Lagrange multiplier of the constraint (27).

Clearing Model of the Hydrogen System

The objective function of the clearing model of the hydrogen system is as follow:

$$min {\sum }_{t ∈ {Φ}^{T}} [ {\sum }_{h ∈ {Φ}^{H}} {c}_{h , t}^{H} \cdot {f}_{h , t}^{H} + {\sum }_{i ∈ {Φ}^{P 2 H}} {\overline{φ}}_{i , t} ( {f}_{i , t}^{P 2 H} - \frac{{\overline{P}}_{i , t}^{P 2 H} \cdot 3600}{HHV \cdot {η}_{i}^{P 2 H}} ) ] \qquad ( 28 )$$

so that the constraints in the equations (7) to (14) and the constraints in the equations (17) and (29) are established.

$$\frac{{f}_{i , t}^{FC} \cdot HHV \cdot {η}_{i}^{FC}}{3600} - {\overline{P}}_{i , t}^{FC} = 0 : {μ}_{i , t} ∀ i , t \qquad ( 29 )$$

where φ̅_{i,t} represents the fixed Lagrange multiplier in the clearing model of the hydrogen system, and P̅_{i,t}^{FC} and P̅_{i,t}^{P2H} represent coupling variables in the clearing model of the hydrogen system; and μ_{i,t} represents a Lagrange multiplier of the constraint (29).

Coupling variables and Lagrange multipliers of the coupling constraints may be obtained by respectively solving the above two decoupling sub-systems, and interaction information may be stored in the blockchain smart contract. The blockchain smart contract may be exchanged through a power sub-system and a hydrogen sub-system for multiple rounds, and a decoupling sub-problem may be iteratively solved, to obtain an optimal solution of the electro-hydrogen integrated system.

In the method according to the embodiments of the present disclosure, the clearing model of the electro-hydrogen integrated system with a minimum operation cost of the electro-hydrogen integrated system as a goal is constructed by considering a network topology structure of the system, a Lagrange multiplier is introduced into each of the hydrogen balance constraint and the power balance constraint in the electro-hydrogen integrated system. The key information in the electro-hydrogen integrated system is reflected based on a marginal price mechanism for the first time, so that a hydrogen price matches a fluctuating power price within a transaction period. Finally, a method of decoupling the electro-hydrogen integrated system based on the optimal condition decomposition is provided. The optimal solution of the clearing model of the electro-hydrogen integrated model is obtained by iteratively updating and exchanging coupling variables and the Lagrange multiplier value of each sub-system, and re-optimizing each sub-problem based on the latest information.

To achieve the above embodiments, an apparatus for coordinated control of an electro-hydrogen integrated system based on a blockchain smart contract is further provided in the disclosure.

### Embodiment 3

FIG. 2 is a diagram illustrating a structure of an apparatus for coordinated control of an electro-hydrogen integrated system based on a blockchain smart contract according to the embodiments of the present disclosure.

As illustrated in FIG. 2, the apparatus for coordinated control of the electro-hydrogen integrated system based on the blockchain smart contract includes a constructing module 100, a matching module 200, a computing module 300, an updating module 400 and a control module 500.

The constructing module 100 is configured to construct a clearing model for the electro-hydrogen integrated system having a fuel cell facility and a power-to-hydrogen (P2H) production facility. An objective function of the clearing model is represented by:

$$min {\sum }_{t ∈ {Φ}^{T}} ( {\sum }_{g ∈ {Φ}^{G}} {c}_{g , t}^{G} \cdot {P}_{g , t}^{G} + {\sum }_{h ∈ {Φ}^{H}} {c}_{h , t}^{H} \cdot {f}_{h , t}^{H} )$$

where Φ^{T} represents a set of measurement moments, Φ^{G} represents a set of generator units, Φ^{H} represents a set of hydrogen sources; P_{g,t}^{G} represents an electric quantity produced by a generator unit g, f_{h,t}^{H} represents a hydrogen amount produced by a hydrogen source h at a t moment; and c_{g,t}^{G} represents a cost coefficient of the generator unit g producing electricity at the t moment, c_{h,t}^{H} represents a cost coefficient of the hydrogen source h producing hydrogen at the t moment.

The match module 200 is configured to introduce Lagrange multipliers into a power balance constraint and a hydrogen energy balance constraint in the clearing model.

The computation module 300 is configured to decompose the clearing model of the electro-hydrogen integrated system into a first clearing model of a power subsystem and a second clearing model of a hydrogen subsystem based on an optimal condition decomposition algorithm, solve the first clearing model and the second clearing model to obtain first Lagrange multipliers and first coupling variables of the power sub-system, and second Lagrange multipliers and second coupling variables of the hydrogen sub-system.

The update module 400 is configured to store the first Lagrange multipliers and the first coupling variables, the second Lagrange multipliers and the second coupling variables in the blockchain smart contract, exchange the blockchain smart contract for multiple rounds through the power sub-system and the hydrogen sub-system and adjust strategies of the power sub-system and the hydrogen sub-system to obtain an optimal solution of the clearing model of the electro-hydrogen integrated system.

The control module 500 is configured to control the electro-hydrogen integrated system based on the optimal solution to provide a target electric quantity and a target hydrogen amount.

In an embodiment, a power balance constraint of each node in a power system is defined by:

$${\sum }_{g ∈ {Φ}_{m}^{G}} {P}_{g , t}^{G} + {\sum }_{i ∈ {Φ}_{m}^{RG}} {P}_{i , t}^{RG} + {\sum }_{i ∈ {Φ}_{m}^{G}} {P}_{i , t}^{FC} - {\sum }_{i ∈ {Φ}_{m}^{G}} {P}_{i , t}^{P 2 H} - {\sum }_{n ∈ {Φ}_{m}^{G}} {P}_{i , t}^{P 2 H} - {\sum }_{n ∈ {Φ}_{m}} {P}_{mn , t}^{f} = {p}_{m , i}^{D}$$

$$∀ t , m ,$$

where Φₘ^{G} represents a set of thermal power generator units, Φₘ^{RG} represents a set of new energy generator units and Φₘ represents a set of nodes connected to a node m; P_{i,t}^{RG} represents an active power output of a new energy generator unit i at a t moment, P_{i,t}^{FC} represents an active power output of a fuel cell i at the t moment, P P2H represents a power consumed by a P2H production facility i at the t moment, P_{m,t}^{D} represents a power demand of a node i at the t moment, and P_{mn,t}^{f} represents a power transmitted from the node m to a node n at the t moment; and
a hydrogen balance constraint of each node in a hydrogen energy system is defined by:

$${\sum }_{h ∈ m} {f}_{h , t}^{H} - {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{P 2 H} - {\sum }_{i ∈ m} {f}_{i , t}^{FC} = {f}_{m , t}^{D} ∀ m , t ,$$

where Ω_{I}(mn)=m represents a set of hydrogen pipelines with the node m as an input node; Ω_{O}(mn)=m represents a set of hydrogen pipelines with the node m as an output node; f_{mn,t}^{I} represents a hydrogen amount input by a hydrogen pipeline mn at the node m at the t moment, f_{mn,t}^{O} represents a hydrogen amount output by the hydrogen pipeline mn at the node m at the t moment; f_{i,t}^{FC} represents a hydrogen consumption of the fuel cell i; f_{i,t}^{P2H} represents a hydrogen production amount of the P2H production facility i; and f_{m,t}^{D} represents a hydrogen energy demand amount of the node m at the t moment.

In another embodiment, a power constraint of a transmission line in the power system is defined by:

P_{mn,t}^{f}=Bₘₙ(θ_{m,t}−θ_{n,t}) ∀t,m,nϵΦₘ,

−P_{mn,max}^{f}≤P_{mn,t}^{f}≤P_{mn,max}^{f} ∀t,m,nϵΦₘ
where P_{mn,max}^{f} represents an upper limit of the transmitting power of the electric transmission line from the node m to a node n;
an output constraint of a set of thermal power generator units is defined by:

P_{i,min}^{G}≤P_{i,t}^{G}≤P_{i,max}^{G} ∀i,t,
where P_{i,max}^{G} represents an output upper limit of a set of thermal power generator units i, and P_{i,min}^{G} represents an output lower limit of the set of thermal power generator units i; and
an output constraint of a set of renewable energy generator units is defined by:

0≤P_{i,t}^{RG}≤P_{i,t}^{FRG} ∀i,t
where P_{i,t}^{FRG} represents an active power output predicted value of a set of renewable energy units i at the moment t.

In another embodiment, a hydrogen pipeline constraint is defined by:

$$\{ \begin{matrix}{f}_{mn , t} = sgn ( {p}_{m , t} , {p}_{n , t} ) \cdot {S}_{mn} \cdot \sqrt{\vert {p}_{m , t}^{2} - {p}_{n , t}^{2} \vert} \\ sgn ( {p}_{m , t} , {p}_{n , t} ) = \{ \begin{matrix}1 & {p}_{m , t} > {p}_{n , t} \\ - 1 & {p}_{m , t} < {p}_{n , t}\end{matrix}\end{matrix} ∀ mn ∈ {Φ}^{L} , t ,$$

where Φ^{L} represents a set of hydrogen pipelines, f_{mn,t} represents a hydrogen amount transmitted by a hydrogen pipeline mn at the t moment, Sₘₙ represents a constant determined by a length, a diameter and a temperature of the pipeline mn, and sgn(p_{m,t}, p_{n,t}) represents a sign function of a hydrogen flow direction, and a hydrogen flow is determined by:

$${f}_{mn , t} = \frac{{f}_{mn , t}^{I} + {f}_{mn , t}^{O}}{2} ∀ mn ∈ {Φ}^{L} , t ,$$

a hydrogen flow constraint in the hydrogen pipeline is defined by:

−f_{mn,max}≤f_{mn,max}≤_{mn,max} ∀mnϵΦ^{L},t,
where f_{mn,max} represents a capacity limit of the pipeline mn;
a pipeline component constraint is determined by:

$${F}_{mn , t} = {F}_{mn , t - 1} + {f}_{mn , t}^{I} - {f}_{mn , t}^{O} ∀ mn ∈ {Φ}^{L} , t ,$$

$${F}_{mn , t} = {μ}_{mn} \cdot \frac{{p}_{m , t} + {p}_{n , t}}{2} ∀ mn ∈ {Φ}^{L} , t$$

where F_{mn,t} represents a hydrogen storage amount within the hydrogen pipeline mn at the t moment, μₘₙ represents a constant determined by a length, a diameter and a temperature of the hydrogen pipeline mn;
a hydrogen production constraint of the hydrogen energy system is defined by:

f_{h,min}^{H}≤f_{h,t}^{H}≤f_{h,max}^{H} ∀h,t
where f_{h,max}^{H} represents an upper limit of a hydrogen production capacity of a hydrogen production source h and f_{h,min}^{H} represents a lower limit of the hydrogen production capacity of the hydrogen production source h;
a hydrogen pressure constraint is represented by:

p_{m,min}≤p_{m,t}≤p_{m,max} ∀m,t,
where p_{m,t} represents a hydrogen pressure of the node m at the t moment, p_{m,max} represents an upper limit of the hydrogen pressure of the node m, and p_{m,min} represents a lower limit of the hydrogen pressure of the node m.

In an embodiment, the match module is further configured to:
introduce a dual variable of the power balance constraint at each node in the power system:

$${\sum }_{g ∈ {Φ}_{m}^{G}} {P}_{g , t}^{G} + {\sum }_{i ∈ {Φ}_{m}^{RG}} {P}_{i , t}^{RG} + {\sum }_{i ∈ {Φ}_{m}^{G}} {P}_{i , t}^{FC} - {\sum }_{i ∈ {Φ}_{m}^{G}} {P}_{i , t}^{P 2 H} - {\sum }_{n ∈ {Φ}_{m}} {P}_{mn , t}^{f} = {p}_{m , t}^{D} : {λ}_{m , t}^{LMP}$$

$$∀ t , m ,$$

where λ_{m,t}^{LMP} represents the introduced dual variable of the power balance constraint; and
introduce a dual variable of the hydrogen balance constraint at each node in the hydrogen energy system:

$${\sum }_{h ∈ m} {f}_{h , t}^{H} - {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{P 2 H} - {\sum }_{i ∈ m} {f}_{i , t}^{FC} = {f}_{m , t}^{D} : {λ}_{m , t}^{MHP}$$

$$∀ m , t ,$$

where λ_{m,t}^{MHP} represents the introduced dual variable of the hydrogen balance constraint.

In an embodiment, the computation module is further configured to:
maintain coupling constraints while decomposing the clearing model into the first clearing model of the power subsystem and the second clearing model of the hydrogen subsystem.

In an embodiment, the coupling constraints comprise:

$${f}_{i , t}^{P 2 H} = \frac{{P}_{i , t}^{P 2 H} \cdot 3600}{HHV \cdot {η}_{i}^{P 2 H}} ∀ i , t ,$$

$${P}_{i , t}^{FC} = \frac{{f}_{i , t}^{FC} \cdot HHV \cdot {η}_{i}^{FC}}{3600} ∀ i , t ,$$

$$0 \leq {f}_{i , t}^{P 2 H} \leq {f}_{i , max}^{P 2 H} ∀ i , t ,$$

$$0 \leq {P}_{i , t}^{FC} \leq {P}_{i , max}^{FC} ∀ i , t ,$$

where P_{i,max}^{FC} represents an installed capacity of the fuel cell facility, f_{i,max}^{P2H} represents an installed capacity of the P2H production facility, p_{m,max} represents an upper limit of a hydrogen pressure of the node m at the t moment, p_{m,min} represents a lower limit of the hydrogen pressure of the node m at the t moment.

In an embodiment, an objective function of the decomposed first clearing model is represented by:

$$min {\sum }_{t ∈ {Φ}^{T}} [ {\sum }_{i ∈ {Φ}^{G}} {c}_{i , t}^{G} \cdot {P}_{g , t}^{G} + {\sum }_{i ∈ {Φ}^{FC}} {\overline{μ}}_{i , t} ( {P}_{i , t}^{FC} - \frac{{\overline{f}}_{i , t}^{FC} \cdot HHV \cdot {η}_{i}^{FC}}{3600} ) ] ,$$

the objective function meets the power balance constraint, and a coupling constraint of

$$\frac{{P}_{i , t}^{P 2 H} \cdot 3600}{HHV \cdot {η}_{i}^{P 2 H}} - {\overline{f}}_{i , t}^{P 2 H} = 0 : {φ}_{i , t} ∀ i , t ,$$

where μ̅_{i,t} represents a fixed Lagrange multiplier obtained from the hydrogen sub-system, f̅_{i,t}^{FC} and f̅_{i,t}^{P2H} represent the first coupling variables, and φ_{i,t} represents a Lagrange multiplier of the coupling constraint, wherein the first Lagrange multipliers include the fixed Lagrange multiplier and the Lagrange multiplier of the coupling constraint.

In an embodiment, an objective function of the decomposed second clearing model is represented by:

$$min {\sum }_{t ∈ {Φ}^{T}} [ {\sum }_{h ∈ {Φ}^{H}} {c}_{h , t}^{H} \cdot {f}_{h , t}^{H} + {\sum }_{i ∈ {Φ}^{P 2 H}} {\overline{φ}}_{i , t} ( {f}_{i , t}^{P 2 H} - \frac{{\overline{{P}_{i , t}}}^{P 2 H} \cdot 3600}{HHV \cdot {η}_{i}^{P 2 H}} ) ] ,$$

the objective function meets the hydrogen energy balance constraint, and a coupling constraint of

$$\frac{{f}_{i , t}^{F C} \cdot HHV \cdot {η}_{i}^{F C}}{3600} - {\overline{P}}_{i , t}^{FC} = 0 : {μ}_{i , t} ∀ i , t ,$$

where φ̅_{i,t} represents a fixed Lagrange multiplier obtained from the power sub-system, P̅_{i,t}^{FC} and P̅_{i,t}^{P2H} represent the second coupling variables, and μ_{i,t} represents a Lagrange multiplier of the coupling constraint, wherein the second Lagrange multipliers include the fixed Lagrange multiplier and the Lagrange multiplier of the coupling constraint.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another. A unit or module may be implemented purely by software, purely by hardware, or by a combination of hardware and software. In a pure software implementation, for example, the unit or module may include functionally related code blocks or software components, that are directly or indirectly linked together, so as to perform a particular function.

According to the apparatus in the embodiment of the disclosure, the interaction information between the power system and the hydrogen system is stored in the smart contract during the actual operation of the power system and the hydrogen system. The electro-hydrogen integrated system is decomposed into the power sub-system and the hydrogen sub-system, each of which maintains their own coupling constraints, and the Lagrange multiplier does not need to be updated during a coordination stage. The power balance constraint and the hydrogen balance constraint in the clearing model of the electro-hydrogen integrated system are rewritten by introducing a marginal price mechanism, so as to reflect key information in the electro-hydrogen integrated system better.

The disclosure also provides a computer device including a memory, a processor and a computer program stored on the memory and executable by the processor. When the computer program is executed by the processor, the method for coordinated control of an electro-hydrogen integrated system based on a blockchain smart contract is implemented.

The disclosure also provides a non-transitory computer-readable storage medium with a computer program stored thereon. When the computer program is executed by a processor, the method for coordinated control of an electro-hydrogen integrated system based on a blockchain smart contract is implemented.

In descriptions of the specification, descriptions with reference to terms “one embodiment”, “some embodiments”, “examples”, “specific examples” or “some examples” etc. mean specific features, structures, materials or characteristics described in conjunction with the embodiment or example are included in at least one embodiment or example of the present disclosure.

In this specification, the schematic representations of the above terms do not have to be the same embodiment or example. Moreover, specific features, structures, materials or characteristics described may be combined in any one or more embodiments or examples in a suitable manner. In addition, those skilled in the art may combine different embodiments or examples and characteristics of different embodiments or examples described in this specification without contradicting each other.

In addition, the terms “first” and “second” used in the present disclosure are only for description purpose, and may not be understood as relative importance of indication or implication or number of technical features indicated by implication. Therefore, features limiting “first” and “second” may explicitly or implicitly include at least one of the features. In the description of the disclosure, “a plurality of” means at least two, for example two, three, etc., unless otherwise specified.

It should be understood that, notwithstanding the embodiments of the present disclosure are shown and described above, the above embodiments are exemplary in nature and shall not be construed as a limitation of the present disclosure. Those skilled in the art may change, modify, substitute and vary the above embodiments within the scope of the disclosure.

What is claimed is:

1. A method for coordinated control of an electro-hydrogen integrated system based on a blockchain smart contract, comprising:
constructing a clearing model for the electro-hydrogen integrated system having a fuel cell facility and a power-to-hydrogen (P2H) production facility, wherein an objective function of the clearing model is represented by:
$$min {\sum }_{f ∈ {Φ}^{T}} ( {\sum }_{g ∈ {Φ}^{G}} {c}_{g , t}^{G} \cdot {P}_{g , t}^{G} + {\sum }_{h ∈ {Φ}^{H}} {c}_{h , t}^{H} \cdot {f}_{h , t}^{H} ) ,$$
where Φ^{T} represents a set of measurement moments, Φ^{G} represents a set of generator units, Φ^{H} represents a set of hydrogen sources; P_{g,t}^{G} represents an electric quantity produced by a generator unit g, f_{h,t}^{H} represents a hydrogen amount produced by a hydrogen source h at a t moment; and c_{g,t}^{G} represents a cost coefficient of the generator unit g producing electricity at the t moment, c_{h,t}^{H} represents a cost coefficient of the hydrogen source h producing hydrogen at the t moment;
introducing Lagrange multipliers into a power balance constraint and a hydrogen energy balance constraint in the clearing model;
decomposing the clearing model into a first clearing model of a power subsystem and a second clearing model of a hydrogen subsystem based on an optimal condition decomposition algorithm, solving the first clearing model and the second clearing model to obtain first Lagrange multipliers and first coupling variables of the power sub-system, and second Lagrange multipliers and second coupling variables of the hydrogen sub-system;
storing the first Lagrange multipliers and the first coupling variables, the second Lagrange multipliers and the second coupling variables in the blockchain smart contract, exchanging the blockchain smart contract for multiple rounds through the power sub-system and the hydrogen sub-system and adjusting strategies of the power sub-system and the hydrogen sub-system to obtain an optimal solution of the clearing model; and
controlling the electro-hydrogen integrated system based on the optimal solution to provide a target electric quantity and a target hydrogen amount.

2. The method according to claim 1, wherein a power balance constraint of each node in a power system is defined by:
$${\sum }_{g ∈ {Φ}_{m}^{G}} {P}_{g , t}^{G} + {\sum }_{i ∈ {Φ}_{m}^{R G}} {P}_{i , t}^{R G} + {\sum }_{i ∈ {Φ}_{m}^{G}} {P}_{i , t}^{F C} - {\sum }_{i ∈ {Φ}_{m}^{G}} {P}_{i , t}^{P 2 H} - {\sum }_{n ∈ {Φ}_{m}} {P}_{mn , t}^{f} = {p}_{m , t}^{D} ∀ t , m ,$$
where Φₘ^{G} represents a set of thermal power generator units, Φₘ^{RG} represents a set of new energy generator units and Φₘ represents a set of nodes connected to a node m; P_{i,t}^{RG} represents an active power output of a new energy generator unit i at a t moment, P_{i,t}^{FC} represents an active power output of a fuel cell i at the t moment, P_{i,t}^{P2H} represents a power consumed by a P2H production facility i at the t moment, P_{m,t}^{D} represents a power demand of a node i at the t moment, and P_{mn,t}^{f} represents a power transmitted from the node m to a node n at the t moment; and
a hydrogen balance constraint of each node in a hydrogen energy system is defined by:
$${\sum }_{h ∈ m} {f}_{h , t}^{H} - {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{P 2 H} - {\sum }_{i ∈ m} {f}_{i , t}^{F C} = {f}_{m , t}^{D} ∀ m , t ,$$
where Ω_{I}(mn)=m represents a set of hydrogen pipelines with the node m as an input node; Ω_{O}(mn)=m represents a set of hydrogen pipelines with the node m as an output node; f_{mn,t}^{I} represents a hydrogen amount input by a hydrogen pipeline mn at the node m at the t moment, f_{mn,t}^{O} represents a hydrogen amount output by the hydrogen pipeline mn at the node m at the t moment; f_{i,t}^{FC} represents a hydrogen consumption of the fuel cell i; f_{i,t}^{P2H} represents a hydrogen production amount of the P2H production facility i; and f_{m,t}^{D} represents a hydrogen energy demand amount of the node m at the t moment.

3. The method according to claim 2, wherein a power constraint of a transmission line in the power system is defined by:
P_{mn,t}^{f}=Bₘₙ(θ_{m,t}−θ_{n,t}) ∀t,m,nϵΦₘ,
−P_{mn,max}^{f}≤P_{mn,t}^{f}≤P_{mn,max}^{f} ∀t,m,nϵΦₘ
where P_{mn,max}^{f} represents an upper limit of the transmitting power of the electric transmission line from the node m to a node n;
an output constraint of a set of thermal power generator units is defined by:
P_{i,min}^{G}≤P_{i,t}^{G}≤P_{i,max}^{G} ∀i,t,
where P_{i,max}^{G} represents an output upper limit of a set of thermal power generator units i, and P_{i,min}^{G} represents an output lower limit of the set of thermal power generator units i; and
an output constraint of a set of renewable energy generator units is defined by:
0≤P_{i,t}^{RG}≤P_{i,t}^{FRG} ∀i,t
where P_{i,t}^{FRG} represents an active power output predicted value of a set of renewable energy units i at the moment t.

4. The method according to claim 2, wherein a hydrogen pipeline constraint is defined by:
$$\{ \begin{matrix}{f}_{mn , t} = sgn ( {p}_{m , t} , {p}_{n , t} ) \cdot {S}_{mn} \cdot \sqrt{\vert {p}_{m , t}^{2} - {p}_{n , t}^{2} \vert} \\ sgn ( {p}_{m , t} , {p}_{n , t} ) = \{ \begin{matrix}1 & {p}_{m , t} > {p}_{n , t} \\ - 1 & {p}_{m , t} < {p}_{n , t}\end{matrix}\end{matrix} ∀ mn ∈ {Φ}^{L} , t ,$$
where Φ^{L} represents a set of hydrogen pipelines, f_{mn,t} represents a hydrogen amount transmitted by a hydrogen pipeline mn at the t moment, Sₘₙ represents a constant determined by a length, a diameter and a temperature of the pipeline mn, and sgn(p_{m,t}, P_{n,t}) represents a sign function of a hydrogen flow direction, and a hydrogen flow is determined by:
$${f}_{mn , t} = \frac{{f}_{mn , t}^{I} + {f}_{mn , t}^{O}}{2} ∀ mn ∈ {Φ}^{L} , t$$
a hydrogen flow constraint in the hydrogen pipeline is defined by:
−f_{mn,max}≤f_{mn,max}≤_{mn,max} ∀mnϵΦ^{L},t,
where f_{mn,max} represents a capacity limit of the pipeline mn;
a pipeline component constraint is determined by:
$${F}_{mn , t} = {F}_{mn , t - 1} + {f}_{m , t}^{I} - {f}_{mn , t}^{O} ∀ mn ∈ {Φ}^{L} , t ,$$
$${F}_{mn , t} = {μ}_{m n} \cdot \frac{{p}_{m , t} + {p}_{n , t}}{2} ∀ mn ∈ {Φ}^{L} , t$$
where F_{mn,t} represents a hydrogen storage amount within the hydrogen pipeline mn at the t moment, μₘₙ represents a constant determined by a length, a diameter and a temperature of the hydrogen pipeline mn;
a hydrogen production constraint of the hydrogen energy system is defined by:
f_{h,min}^{H}≤f_{h,t}^{H}≤f_{h,max}^{H} ∀h,t
where f_{h,max}^{H} represents an upper limit of a hydrogen production capacity of a hydrogen production source h and f_{h,min}^{H} represents a lower limit of the hydrogen production capacity of the hydrogen production source h;
a hydrogen pressure constraint is represented by:
p_{m,min}≤p_{m,t}≤p_{m,max} ∀m,t,
where p_{m,t} represents a hydrogen pressure of the node m at the t moment, p_{m,max} represents an upper limit of the hydrogen pressure of the node m, and p m, n represents a lower limit of the hydrogen pressure of the node m.

5. The method according to claim 2, wherein introducing Lagrange multipliers into the power balance constraint and the hydrogen energy balance constraint in the clearing model comprises:
introducing a dual variable of the power balance constraint at each node in the power system:
$${\sum }_{g ∈ {Φ}_{m}^{G}} {P}_{g , t}^{G} + {\sum }_{i ∈ {Φ}_{m}^{R G}} {P}_{i , t}^{R G} + {\sum }_{i ∈ {Φ}_{m}^{G}} {P}_{i , t}^{F C} - {\sum }_{i ∈ {Φ}_{m}^{G}} {P}_{i , t}^{P 2 H} - {\sum }_{n ∈ {Φ}_{m}} {P}_{m n , t}^{f} = {p}_{m , t}^{D} : {λ}_{m , t}^{LMP}$$
$$∀ t , m ,$$
where λ_{m,t}^{LMP} represents the introduced dual variable of the power balance constraint; and
introducing a dual variable of the hydrogen balance constraint at each node in the hydrogen energy system:
$${\sum }_{h ∈ m} {f}_{h , t}^{H} - {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{P 2 H} - {\sum }_{i ∈ m} {f}_{i , t}^{F C} = {f}_{m , t}^{D} : {λ}_{m , t}^{MHP} ∀ m , t$$
where λ_{m,t}^{MHP} represents the introduced dual variable of the hydrogen balance constraint.

6. The method according to claim 1, further comprising:
maintaining coupling constraints while decomposing the clearing model into the first clearing model of the power subsystem and the second clearing model of the hydrogen subsystem.

7. The method according to claim 6, wherein the coupling constraints comprise:
$${f}_{i , t}^{P 2 H} = \frac{{P}_{i , t}^{P 2 H} \cdot 3600}{HHV \cdot {η}_{i}^{P 2 H}} ∀ i , t ,$$
$${P}_{i , t}^{F C} = \frac{{f}_{i , t}^{F C} \cdot HHV \cdot {η}_{i}^{F C}}{3600} ∀ i , t ,$$
$$0 \leq {f}_{i , t}^{P 2 H} \leq {f}_{i , max}^{P 2 H} ∀ i , t ,$$
$$0 \leq {P}_{i , t}^{F C} \leq {P}_{i , max}^{F C} ∀ i , t ,$$
where P_{i,max}^{FC} represents an installed capacity of the fuel cell facility, f_{i,max}^{P2H} represents an installed capacity of the P2H production facility, p_{m,max} represents an upper limit of a hydrogen pressure of the node m at the t moment, p_{m,min} represents a lower limit of the hydrogen pressure of the node m at the t moment.

8. The method according to claim 1, wherein an objective function of the decomposed first clearing model is represented by:
$$min {\sum }_{t ∈ {Φ}^{T}} [ {\sum }_{i ∈ {Φ}^{G}} {c}_{i , t}^{G} \cdot {P}_{g , t}^{G} + {\sum }_{i ∈ {Φ}^{F C}} {\overline{μ}}_{i , t} ( {P}_{i , t}^{F C} - \frac{{\overline{{f}_{i , t}}}^{F C} HHV \cdot {η}_{i}^{F C}}{3600} ) ] ,$$
the objective function meets the power balance constraint, and a coupling constraint of
$$\frac{{P}_{i , t}^{P 2 H} \cdot 3600}{HHV \cdot {η}_{i}^{P 2 H}} - {\overline{f}}_{i , t}^{P 2 H} = 0 : {φ}_{i , t} ∀ i , t ,$$
where μ̅_{i,t} represents a fixed Lagrange multiplier obtained from the hydrogen sub-system, f̅_{i,t}^{FC} and f̅_{i,t}^{P2H} represent the first coupling variables, and φ_{i,t} represents a Lagrange multiplier of the coupling constraint, wherein the first Lagrange multipliers comprise the fixed Lagrange multiplier and the Lagrange multiplier of the coupling constraint.

9. The method according to claim 1, wherein an objective function of the decomposed second clearing model is represented by:
$$min {\sum }_{t ∈ {Φ}^{T}} [ {\sum }_{h ∈ {Φ}^{H}} {c}_{h , t}^{H} \cdot {f}_{h , t}^{H} + {\sum }_{i ∈ {Φ}^{P 2 H}} {\overline{φ}}_{i , t} ( {f}_{i , t}^{P 2 H} - \frac{{\overline{P}}_{i , t}^{P 2 H} \cdot 3600}{HHV \cdot {η}_{i}^{P 2 H}} ) ] ,$$
the objective function meets the hydrogen energy balance constraint, and a coupling constraint of
$$\frac{{f}_{i , t}^{FC} \cdot HHV \cdot {η}_{i}^{FC}}{3600} - {\overline{P}}_{i , t}^{FC} = 0 : {μ}_{i , t} ∀ i , t ,$$
where φ̅_{i,t} represents a fixed Lagrange multiplier obtained from the power sub-system, P̅_{i,t}^{FC} and P̅_{i,t}^{P2H} represent the second coupling variables, and μ_{i,t} represents a Lagrange multiplier of the coupling constraint, wherein the second Lagrange multipliers comprise the fixed Lagrange multiplier and the Lagrange multiplier of the coupling constraint.

10. An electro-hydrogen integrated system, comprising:
a fuel cell facility and a power-to-hydrogen (P2H) production facility, configured to couple a power system and a hydrogen energy system; and
a controller, configured to:
construct a clearing model for the electro-hydrogen integrated system, wherein an objective function of the clearing model is represented by:
$$min {\sum }_{t ∈ {Φ}^{T}} ( {\sum }_{g ∈ {Φ}^{G}} {c}_{g , t}^{G} \cdot {P}_{g , t}^{G} + {\sum }_{h ∈ {Φ}^{H}} {c}_{h , t}^{H} \cdot {f}_{h , t}^{H} ) ,$$
where Φ^{T} represents a set of measurement moments, Φ^{G} represents a set of generator units, Φ^{H} represents a set of hydrogen sources; P_{g,t}^{G} represents an electric quantity produced by a generator unit g, f_{h,t}^{H} represents a hydrogen amount produced by a hydrogen source h at a t moment; and c_{g,t}^{G} represents a cost coefficient of the generator unit g producing electricity at the t moment, c_{h,t}^{H} represents a cost coefficient of the hydrogen source h producing hydrogen at the t moment;
introduce Lagrange multipliers into a power balance constraint and a hydrogen energy balance constraint in the clearing model;
decompose the clearing model into a first clearing model of a power subsystem and a second clearing model of a hydrogen subsystem based on an optimal condition decomposition algorithm, solving the first clearing model and the second clearing model to obtain first Lagrange multipliers and first coupling variables of the power sub-system, and second Lagrange multipliers and second coupling variables of the hydrogen sub-system;
storing the first Lagrange multipliers and the first coupling variables, the second Lagrange multipliers and the second coupling variables in a blockchain smart contract, exchanging the blockchain smart contract for multiple rounds through the power sub-system and the hydrogen sub-system and adjusting strategies of the power sub-system and the hydrogen sub-system to obtain an optimal solution of the clearing model; and
control the fuel cell facility and the P2H production facility based on the optimal solution to provide a target electric quantity and a target hydrogen amount.

11. The integrated system according to claim 10, wherein a power balance constraint of each node in a power system is defined by:
$${\sum }_{g ∈ {Φ}_{m}^{G}} {P}_{g , t}^{G} + {\sum }_{i ∈ {Φ}_{m}^{RG}} {P}_{i , t}^{RG} + {\sum }_{i ∈ {Φ}_{m}^{G}} {P}_{i , t}^{FC} - {\sum }_{i ∈ {Φ}_{m}^{G}} {P}_{i , t}^{P2H} - {\sum }_{n ∈ {Φ}_{m}} {P}_{mn , t}^{f} = {p}_{m , t}^{D} ∀ t , m ,$$
where Φₘ^{G} represents a set of thermal power generator units, Φₘ^{RG} represents a set of new energy generator units and Φₘ represents a set of nodes connected to a node m; P_{i,t}^{RG} represents an active power output of a new energy generator unit i at a t moment, P_{i,t}^{FC} represents an active power output of a fuel cell i at the t moment, P_{i,t}^{P2H} represents a power consumed by a P2H production facility i at the t moment, P_{i,t}^{P2H} represents a power demand of a node i at the t moment, and P_{mn,t}^{f} represents a power transmitted from the node m to a node n at the t moment; and
a hydrogen balance constraint of each node in a hydrogen energy system is defined by:
$${\sum }_{h ∈ m} {f}_{h , t}^{H} - {\sum }_{{Ω}_{I} ( mn ) = m} {f}_{mn , t}^{I} + {\sum }_{{Ω}_{O} ( mn ) = m} {f}_{mn , t}^{O} + {\sum }_{i ∈ m} {f}_{i , t}^{P 2 H} - {\sum }_{i ∈ m} {f}_{i , t}^{FC} = {f}_{m , t}^{D} ∀ m , t ,$$
where Ω_{I} (mn)=m represents a set of hydrogen pipelines with the node m as an input node; Ω_{O} (mn)=m represents a set of hydrogen pipelines with the node m as an output node; f_{mn,t}^{I} represents a hydrogen amount input by a hydrogen pipeline mn at the node m at the t moment, f_{mn,t}^{O} represents a hydrogen amount output by the hydrogen pipeline mn at the node m at the t moment; f_{i,t}^{FC} represents a hydrogen consumption of the fuel cell i; f_{i,t}^{P2H} represents a hydrogen production amount of the P2H production facility i; and f_{m,t}^{D} represents a hydrogen energy demand amount of the node m at the t moment.

12. The integrated system according to claim 11, wherein a power constraint of a transmission line in the power system is defined by:
P_{mn,t}^{f}=Bₘₙ(θ_{m,t}−θ_{n,t}) ∀t,m,n,ϵΦₘ,
−P_{mn,max}^{f}≤P_{mn,t}^{f}≤P_{mn,max}^{f} ∀t,m,nϵΦₘ
where P_{mn,max}^{f} represents an upper limit of the transmitting power of the electric transmission line from the node m to a node n;
an output constraint of a set of thermal power generator units is defined by:
P_{i,min}^{G}≤P_{i,t}^{G}≤P_{i,max}^{G} ∀i,t,
where P_{i,min}^{G} represents an output upper limit of a set of thermal power generator units i, and P_{i,min}^{G} represents an output lower limit of the set of thermal power generator units i; and
an output constraint of a set of renewable energy generator units is defined by:
0≤P_{i,t}^{RG}≤P_{i,t}^{FRG} ∀i,t
where P_{i,t}^{FRG} represents an active power output predicted value of a set of renewable energy units i at the moment t.

13. The integrated system according to claim 2, wherein a hydrogen pipeline constraint is defined by:
$$\{ \begin{matrix}{f}_{mn , t} = sgn ( {p}_{m , t} , {p}_{n , t} ) \cdot {S}_{mn} \cdot \sqrt{\vert {p}_{m , t}^{2} - {p}_{n , t}^{2} \vert} \\ sgn ( {p}_{m , t} , {p}_{n , t} ) = \{ \begin{matrix}1 & {p}_{m , t} > {p}_{n , t} \\ - 1 & {p}_{m , t} < {p}_{n , t}\end{matrix}\end{matrix} ∀ mn ∈ {Φ}^{L} , t ,$$
where Φ^{L} represents a set of hydrogen pipelines, f_{mn,t} represents a hydrogen amount transmitted by a hydrogen pipeline mn at the t moment, Sₘₙ represents a constant determined by a length, a diameter and a temperature of the pipeline mn, and sgn(p_{m,t}, p_{n,t}) represents a sign function of a hydrogen flow direction, and a hydrogen flow is determined by:
$${f}_{mn , t} = \frac{{f}_{mn , t}^{I} + {f}_{mn , t}^{O}}{2} ∀ mn ∈ {Φ}^{L} , t$$
a hydrogen flow constraint in the hydrogen pipeline is defined by:
−f_{mn,max}≤f_{mn,t}≤f_{mn,max} ∀mnϵΦ^{L},t,
where f_{mn,max} represents a capacity limit of the pipeline mn;
a pipeline component constraint is determined by:
$${F}_{mn , t} = {F}_{mn , t - 1} + {f}_{mn , t}^{I} - {f}_{mn , t}^{o} ∀ mn ∈ {Φ}^{L} , t , \\ {F}_{mn , t} = {μ}_{mn} \cdot \frac{{p}_{m , t} + {p}_{n , t}}{2} ∀ mn ∈ {Φ}^{L} , t$$
where F_{mn,t} represents a hydrogen storage amount within the hydrogen pipeline mn at the t moment, μₘₙ represents a constant determined by a length, a diameter and a temperature of the hydrogen pipeline mn;
a hydrogen production constraint of the hydrogen energy system is defined by:
f_{h,min}^{H}≤f_{h,t}^{H}≤f_{h,max}^{H} ∀h,t
where f_{h,max}^{H} represents an upper limit of a hydrogen production capacity of a hydrogen production source h and f_{h,min}^{H} represents a lower limit of the hydrogen production capacity of the hydrogen production source h;
a hydrogen pressure constraint is represented by:
p_{m,min}≤p_{m,t}≤p_{m,max} ∀m,t,
where p_{m,t} represents a hydrogen pressure of the node m at the t moment, p_{m,max} represents an upper limit of the hydrogen pressure of the node m, and p_{m,min} represents a lower limit of the hydrogen pressure of the node m.

14. The integrated system according to claim 11, wherein the controller is further configured to:
introduce a dual variable of the power balance constraint at each node in the power system:
$${\sum }_{g ∈ {Φ}_{m}^{G}} {P}_{g , t}^{G} + {\sum }_{i ∈ {Φ}_{m}^{RG}} {P}_{i , t}^{RG} + {\sum }_{i ∈ {Φ}_{m}^{G}} {P}_{i , t}^{FC} -$$
$${\sum }_{i ∈ {Φ}_{m}^{G}} {P}_{i , t}^{P 2 H} - {\sum }_{n ∈ {Φ}_{m}} {P}_{mn , t}^{f} = {p}_{m , t}^{D} : {λ}_{m , t}^{LMP} ∀ t , m ,$$
where λ_{m,t}^{LMP} represents the introduced dual variable of the power balance constraint; and
introduce a dual variable of the hydrogen balance constraint at each node in the hydrogen energy system:
$${\sum }_{h ∈ m} {f}_{h , t}^{H} - {\sum }_{{Ω}_{I} ( mn ) = m} {f}_{mn , t}^{I} + {\sum }_{{Ω}_{0} ( mn ) = m} {f}_{mn , t}^{O} + {\sum }_{i ∈ m} {f}_{i , t}^{P 2 H} - {\sum }_{i ∈ m} {f}_{i , t}^{FC} = {f}_{m , t}^{D} : {λ}_{m , t}^{MHP} ∀ m , t$$
where λ_{m,t}^{MHP} represents the introduced dual variable of the hydrogen balance constraint.

15. The integrated system according to claim 10, wherein the controller is further configured to:
maintain coupling constraints while decomposing the clearing model into the first clearing model of the power subsystem and the second clearing model of the hydrogen subsystem.

16. The integrated system according to claim 15, wherein the coupling constraints comprise:
$${f}_{i , t}^{P 2 H} = \frac{{P}_{i , t}^{P 2 H} \cdot 3600}{HHV \cdot {η}_{i}^{P 2 H}} ∀ i , t , \\ {P}_{i , t}^{FC} = \frac{{f}_{i , t}^{FC} \cdot HHV \cdot {η}_{i}^{FC}}{3600} ∀ i , t , \\ 0 \leq {f}_{i , t}^{P 2 H} \leq {f}_{i , max}^{P 2 H} ∀ i , t , \\ 0 \leq {P}_{i , t}^{FC} \leq {P}_{i , max}^{FC} ∀ i , t ,$$
where P_{i,maxFC} represents an installed capacity of the fuel cell facility, f_{i,min}^{P2H} represents an installed capacity of the P2H production facility, p_{m,max} represents an upper limit of a hydrogen pressure of the node m at the t moment, p_{m,min} represents a lower limit of the hydrogen pressure of the node m at the t moment.

17. The integrated system according to claim 10, wherein an objective function of the decomposed first clearing model is represented by:
$$min {\sum }_{t ∈ {Φ}^{T}} [ {\sum }_{i ∈ {Φ}^{G}} {c}_{i , t}^{G} \cdot {P}_{g , t}^{G} + {\sum }_{i ∈ {Φ}^{FC}} {\overline{μ}}_{i , t} ( {P}_{i , t}^{FC} - \frac{{\overline{f}}_{i , t}^{FC} \cdot HHV \cdot {η}_{i}^{FC}}{3600} ) ] ,$$
the objective function meets the power balance constraint, and a coupling constraint of
$$\frac{{P}_{i , t}^{P 2 H} \cdot 3600}{HHV \cdot {η}_{i}^{P 2 H}} - {\overline{f}}_{i , t}^{P 2 H} = 0 : {φ}_{i , t} ∀ i , t ,$$
where μ̅_{i,t} represents a fixed Lagrange multiplier obtained from the hydrogen sub-system, f̅_{i,t}^{FPC} and f̅_{i,t}^{P2H} represent the first coupling variables, and φ_{i,t} represents a Lagrange multiplier of the coupling constraint, wherein the first Lagrange multipliers comprise the fixed Lagrange multiplier and the Lagrange multiplier of the coupling constraint.

18. The integrated system according to claim 10, wherein an objective function of the decomposed second clearing model is represented by:
$$min {\sum }_{t ∈ {Φ}^{T}} [ {\sum }_{h ∈ {Φ}^{H}} {c}_{h , t}^{H} \cdot {f}_{h , t}^{H} + {\sum }_{i ∈ {Φ}^{P 2 H}} {\overline{φ}}_{i , t} ( {f}_{i , t}^{P 2 H} - \frac{{\overline{P}}_{i , t}^{P 2 H} \cdot 3600}{HHV \cdot {η}_{i}^{P 2 H}} ) ] ,$$
the objective function meets the hydrogen energy balance constraint, and a coupling constraint of
$$\frac{{f}_{i , t}^{FC} \cdot HHV \cdot {η}_{i}^{FC}}{3600} - {\overline{P}}_{i , t}^{FC} = 0 : {μ}_{i , t} ∀ i , t ,$$
where φ̅_{i,t} represents a fixed Lagrange multiplier obtained from the power sub-system, P̅_{i,t}^{FC} and P̅_{i,t}^{P2H} represent the second coupling variables, and μ_{i,t} represents a Lagrange multiplier of the coupling constraint, wherein the second Lagrange multipliers comprise the fixed Lagrange multiplier and the Lagrange multiplier of the coupling constraint.

19. A non-transitory computer computer-readable storage medium having a computer program stored thereon, wherein when the computer program is executed by a processor, a method for coordinated control of an electro-hydrogen integrated system based on a blockchain smart contract is implemented, the method comprising:
constructing a clearing model for the electro-hydrogen integrated system having a fuel cell facility and a power-to-hydrogen (P2H) production facility, wherein an objective function of the clearing model is represented by:
$$min {\sum }_{t ∈ {Φ}^{T}} ( {\sum }_{g ∈ {Φ}^{G}} {c}_{g , t}^{G} \cdot {P}_{g , t}^{G} + {\sum }_{h ∈ {Φ}^{H}} {c}_{h , t}^{H} \cdot {f}_{h , t}^{H} ) ,$$
where Φ^{T} represents a set of measurement moments, Φ^{G} represents a set of generator units, Φ^{H} represents a set of hydrogen sources; P_{g,t}^{G} represents an electric quantity produced by a generator unit g, f_{h,t}^{H} represents a hydrogen amount produced by a hydrogen source h at a t moment; and c_{g,t}^{G} represents a cost coefficient of the generator unit g producing electricity at the t moment, c_{g,t}^{H} represents a cost coefficient of the hydrogen source h producing hydrogen at the t moment;
introducing Lagrange multipliers into a power balance constraint and a hydrogen energy balance constraint in the clearing model;
decomposing the clearing model into a first clearing model of a power subsystem and a second clearing model of a hydrogen subsystem based on an optimal condition decomposition algorithm, solving the first clearing model and the second clearing model to obtain first Lagrange multipliers and first coupling variables of the power sub-system, and second Lagrange multipliers and second coupling variables of the hydrogen sub-system;
storing the first Lagrange multipliers and the first coupling variables, the second Lagrange multipliers and the second coupling variables in the blockchain smart contract, exchanging the blockchain smart contract for multiple rounds through the power sub-system and the hydrogen sub-system and adjusting strategies of the power sub-system and the hydrogen sub-system to obtain an optimal solution of the clearing model; and
controlling the electro-hydrogen integrated system based on the optimal solution to provide a target electric quantity and a target hydrogen amount.
